(19) United States
(12) Patent Application Publication
(10) Pub. No.: US 2017/0172072 A1
(43) Pub. Date: Jun. 22, 2017

(54) Plant Support Apparatus

(71) Applicant: Mark A. Jablonski, Worcester, MA (US)

(72) Inventor: Mark A. Jablonski, Worcester, MA (US)

(21) Appl. No.: 14/962,395

(22) Filed: Dec. 21, 2015

(51) Int. Cl. A01G 9/12

(52) U.S. Cl. CPC A01G 9/128; A01G 9/122

(57) ABSTRACT

The present application discloses a plant support device that includes a single support strut, aligned approximately in a vertical direction when in use, and one or more enclosing fixtures, each mounted on a first support strut with its own first hinge, wherein each first hinge enables a substantially vertical swing relative to the support strut when in use, and wherein each first hinge is operatively coupled to a detent for holding the enclosing fixture at selected angles relative to the support strut.

### FIELD OF THE INVENTION

The present application for patent is in the field of gardening, and more specifically, in the field of holding heavy garden plants and vines off the ground.

### BACKGROUND

Plant supports typically consist of a stake driven into the ground next to the plant, to which the plant stem (a term used here generically to include the trunk and branches of bushes, sapling trees, vines and the like) is held by means of attachments or ties, such as string, wire ties or straps of plastic or of other flexible materials. They have been used by horticulturalists for some time. However, the stake is usually driven into the soil near the base of the stem, which can inflict damage on the root ball of the plant. Moreover, tying the plant to a stake may interfere with stem growth in length and girth, causing deformities in the stem and potential damage to plant products such as fruits and vegetables.

A variety of other plant support structures are known in the art U.S. Pat. No. 7,735,259, issued Jun. 15, 2010, discloses stakes and cross braces attached to each other by means of clamps. U.S. Patent Application Publication No. 2005/0039394 discloses a plant support structure comprising stakes, hoops and clamps. Further, U.S. Patent Application Publication No. 2015/0059241 discloses a plant support structure comprising two or more support rods and two or more bracing members that comprise fasteners and generally annular structures such as “hoops.”

The above devices may generally be used to hold plants off the ground. However, sturdy support for the plant often depends on the vertical structures going sufficiently deep into the ground so that plants, heavy with their fruits or vegetables will not tip over. With more than one support pole, it is often difficult to penetrate the ground with each pole while avoiding rocks, roots or other obstructions in the soil. In addition, the fixtures that enclose the plant are arranged at fixed positions such that the plant may be damaged when it is pulled through them. These deficiencies are addressed by the subject matter disclosed and claimed herein.

### BRIEF DESCRIPTION OF THE DRAWINGS

FIG. 1 illustrates an embodiment of a plant support device. FIG. 1(a) illustrates an enclosing fixture in a partially lowered position and in a lowered position. FIG. 1(b) illustrates a plant support device with its three enclosing fixtures in a lowered position.

FIG. 2 illustrates an embodiment of a plant support device. FIG. 2(a) illustrates an embodiment of a plant support device with its three enclosing fixtures in a raised position. FIG. 2(b) illustrates a side view of an embodiment of a plant support device with its three enclosing fixtures in a lowered position. FIG. 2(c) illustrates a side view of an embodiment of a plant support device with its three enclosing fixtures in a raised position.

FIG. 3 illustrates various views of an embodiment of an enclosing fixture. FIG. 3(a) illustrates an enclosing fixture in an open and closed position. FIG. 3(b) illustrates a side view of an enclosing fixture showing an example of a hook and eye locking mechanism.

FIG. 4 illustrates two embodiments of a plant support device. FIG. 4(a) illustrates a plant support device having a pointed end for mounting in the ground. FIG. 4(b) illustrates a plant support device having an auger end for mounting in the ground.

FIG. 5 illustrates an embodiment of a plant support device having a collapsible support strut.

### DETAILED DESCRIPTION OF THE DRAWINGS

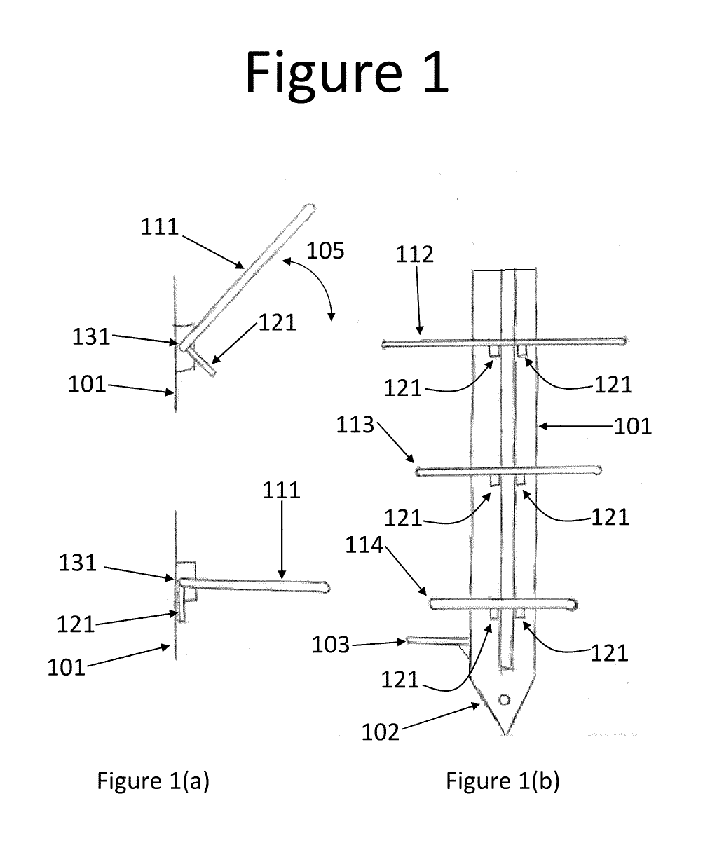

FIG. 1 illustrates an embodiment of a plant support device. FIG. 1(a) illustrates an enclosing fixture in a partially lowered position and in a lowered position. A first hinge 131 is shown mounted on the support strut 101 that is operatively coupled to an enclosing fixture 111. The enclosing fixture 111 is hinged to allow a substantially vertical swing 105 into position and is constrained by a detent, in this case, an L-shaped fixture, mounted on the enclosing fixture 121. FIG. 1(b) illustrates a plant support device with its three enclosing fixtures in a lowered position. A support strut 101 with a tipped bottom for penetrating the soil 102 and a foot fixture for pushing the plant support device into the ground 103. Mounted on the support strut 101 are the hinges (not shown) that hold the enclosing fixtures 112-114 and detents 121 mounted so as to limit the angle of the swing of the enclosing fixtures on their respective hinges.

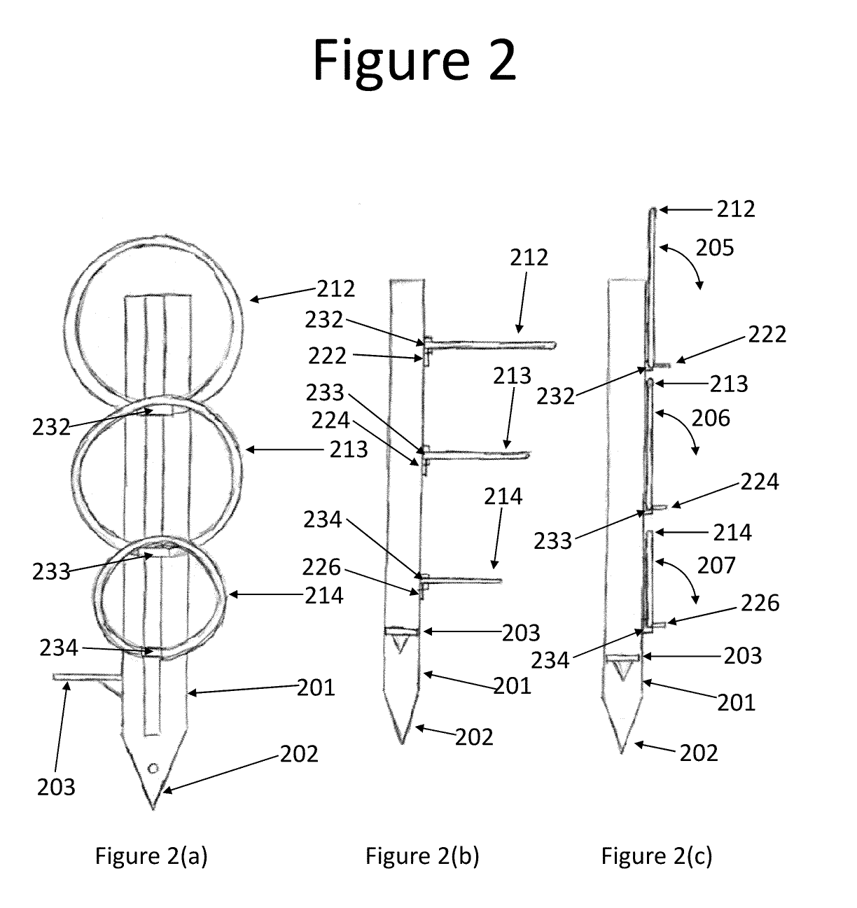

FIG. 2 illustrates an embodiment of a plant support device. FIG. 2(a) illustrates an embodiment of a plant support device with its three enclosing fixtures in a raised position. Shown are the support strut 201 a tipped bottom for penetrating the soil 202 and a foot fixture for pushing the plant support device into the ground 203. The three enclosing fixtures 212-214 are mounted on their respective first hinges 232-234. FIG. 2(b) illustrates a side view of an embodiment of a plant support device with its three enclosing fixtures in a lowered position. Shown are the support strut 201 a tipped bottom for penetrating the soil 202 and a foot fixture for pushing the plant support device into the ground (in side view) 203. The three enclosing fixtures 212-214 are mounted on their respective first hinges 232-234 and held in place, respectively, by detents 222, 224, and 226. FIG. 2(c) illustrates a side view of an embodiment of a plant support device with its three enclosing fixtures in a raised position. Shown are the support strut 201 a tipped bottom for penetrating the soil 202 and a foot fixture for pushing the plant support device into the ground (in side view) 203. The three enclosing fixtures 212-214 are mounted on their respective first hinges 232-234 and have their respective detents 222, 224, and 226. When in use, one or more of the support fixtures may be lowered or raised on its respective first hinge in a substantially vertical swing, indicated respectively by 205-207.

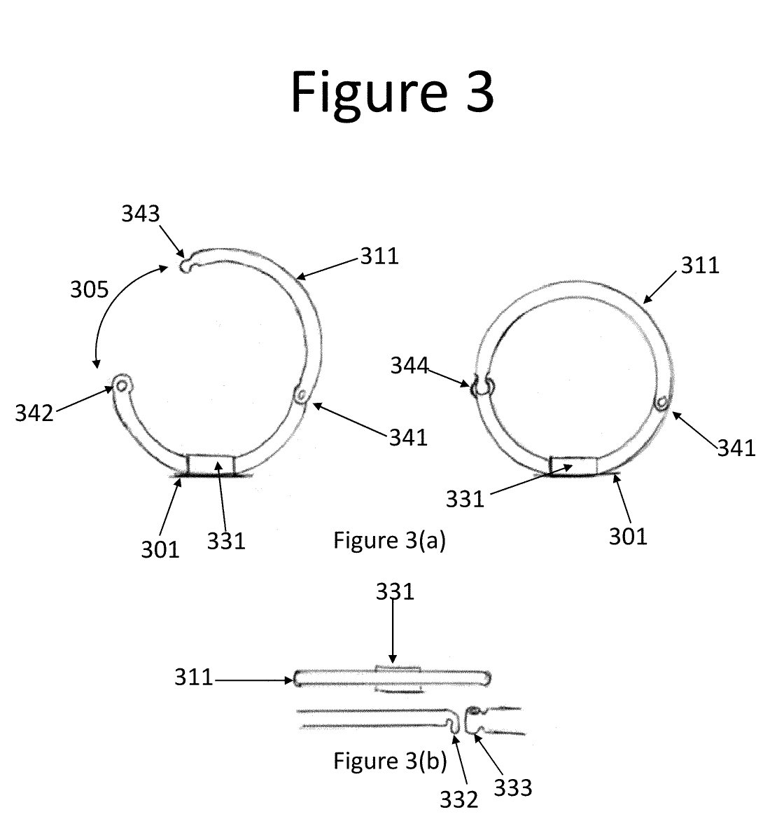

FIG. 3 illustrates various views of an embodiment of an enclosing fixture. FIG. 3(a) illustrates an enclosing fixture in an open and closed position. The enclosing fixture 311 is mounted to a support strut 301 via a first hinge 331. A second hinge 341 allows the enclosing fixture to open and close 305 such that the two ends, 342-343 are fastened, exemplified by 344. FIG. 3(b) illustrates a side view of an enclosing fixture 311 on a hinge 331 showing an example of a hook 332 and eye 333 holding mechanism.

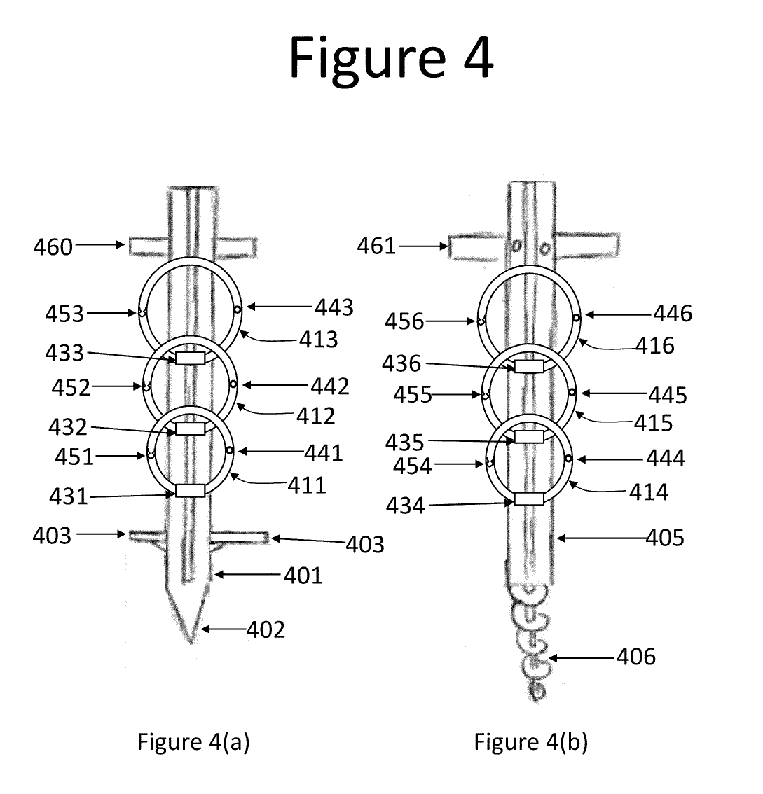

FIG. 4 illustrates two embodiments of a plant support device. FIG. 4(a) illustrates a plant support device having a pointed end for mounting in the ground. A support strut 401 has a pointed end 402 and one or more foot fixtures 403 to anchor the plant support device into the ground. Three enclosing fixtures 411-413 are mounted to the support strut via their respective first hinges 431-433. For purposes of this illustration, the detents (not shown) are understood to reside in the hinge housing while nonetheless as separate units. In this example, each enclosing fixture is equipped with a second hinge 441-443 that allows the enclosing fixture to open and close to support the plant without damage. In addition, each enclosing fixture having a second hinge as shown is shown in this example to have a locking mechanism 451-453. The plant support device may also have a hand grip, 460. FIG. 4(b) illustrates a plant support device having an auger end for mounting in the ground. A support strut 405 has an auger end 406 to anchor the plant support device into the ground. Three enclosing fixtures 414-416 are mounted to the support strut via their respective first hinges 434-436. In this example, each enclosing fixture is equipped with a second hinge 444-446 that allows the enclosing fixture to open and close to support the plant without damage. In addition, each enclosing fixture having a second hinge as shown is shown in this example to have a locking mechanism 454-456. The plant support device may also have a hand grip, 461.

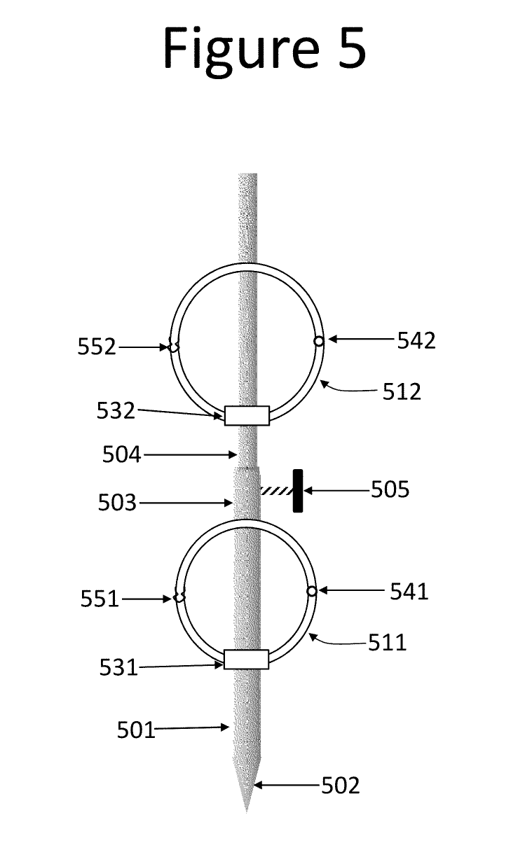

FIG. 5 illustrates an embodiment of a plant support device having a collapsible support strut. A collapsible support strut 501 has an end 502 to anchor the plant support device into the ground. Shown is a pointed end but the support strut of this embodiment may have an auger end. two enclosing fixtures 511, 512 are mounted to the support strut via their respective first hinges 531, 532. For purposes of this illustration, the detents (not shown) are understood to reside in the hinge housing while nonetheless as separate units. In this example, each enclosing fixture is equipped with a second hinge 541, 542 that allows the enclosing fixture to open and close to support the plant without damage. In addition, each enclosing fixture having a second hinge as shown is shown in this example to have a locking mechanism 551, 552. The support strut may also comprise sections, 503, 504 that are configured to allow extension or retraction of the support strut, wherein either configuration may be held in place by a holding device such as a set screw 505.

### DETAILED DESCRIPTION

As used herein, the conjunction “and” is intended to be inclusive and the conjunction “or” is not intended to be exclusive unless otherwise indicated or required by the context. For example, the phrase “or, alternatively” is intended to be exclusive.

As used herein, the words “comprise” or “comprising” are understood in a non-limiting sense to mean that items following the word are included, but items not specifically mentioned are not excluded. The words, “include” and “contain” may be used interchangeably with the “comprise,” as may be appropriate.

As used herein, the word “exemplary” is understood to be an adjective serving to point out an illustrative example and is not intended to indicate preference in any way.

A reference to an element by the indefinite article “a” does not exclude the possibility that more than one of the elements is present, unless the context clearly requires that there be one and only one of the elements. Thus the statement that a structure comprises two specified elements includes the possibility that the structure includes two, three, four or more such specified elements, as well as unspecified elements.

As used herein, the term “plant” is not limiting and while in one embodiment, the support apparatus disclosed herein is suitable for supporting tomato plants, it is not intended that the use of the plant support apparatus be limited to tomato plants or to any specific plant types. In embodiments, the support struts, enclosing fixtures, and hinge(s) hereof are used with or for all manner and variety of plants, shrubs, vines, small trees and the like, and those skilled in the art will readily identify and implement suitable adaptations for use with particular plant types. Without limitation plant support apparatuses according to embodiments are suitable to support all manner of climbing and fruit bearing plants and plants requiring additional support for their growth and by way of example and not limitation support apparatuses according to embodiments are suitable for use with all manner of climbing plants such as peas, snap peas, snow peas, fruit bearing plants such as fruit trees, such as orange, lemon, apple, pear, peach, cherry, flowering plants such as those with heavy flowers such as peonies, and sunflowers, and vines such as grape, tomato, and cucumber. Further non limiting examples of particular plant types with which embodiments are useable include beans, tomatoes, cucumbers, melons, pumpkins, roses, lilies, peonies, clematis, morning glory, wisteria and sunflower. In addition, the term “plant” should not be limiting as by biological kingdom taxonomy. For example, certain embodiments may be suitable for supporting fungi, with or without a stipe, such as mushrooms.

As used herein the terms “support strut” or “strut” are used interchangeably and mean any substantially elongated structure that is or can be used in combination with hinges and enclosing fixtures according to embodiments to form a plant support apparatus. In particular embodiments, support struts include, but are not limited to, stakes commonly used in gardening, and in alternative embodiments is or may comprise any elongate rod, stick, stake, pole, cane or support and may include wooden stakes, rebar, bamboo sticks, canes, metal rods and the like. In embodiments the support struts may comprise two or more segments. In alternative embodiments, support struts may consist of or comprise any material and may be of any suitable lengths, widths, depths, or diameters. In other embodiments, the support strut may have variety of cross sections, such as, without limitation, triangular, square, rectangular, circular, elliptical, oval shaped, i-beam, s-beam, i-beam, c-beam, t-beam n-beam, m-beam, n-sided polygonal, where n=5 to 20, conical and the like. In addition, the support strut cross section may comprise combinations of the above or have a generally geometrical shape such as those supra but with additional protrusions such as barbs or other structures that help to anchor the support strut in the ground or impart strength while minimizing materials and weight.

As used herein, the term “strut” is understood to be a structural component designed to resist longitudinal compression. Struts are understood to provide support in their generally lengthwise direction.

Disclosed herein is a plant support device comprising: a single support strut, aligned approximately in a vertical direction when in use; one or more enclosing fixtures, each mounted on a first support strut with its own first hinge, wherein each first hinge enables a substantially vertical swing relative to the single support strut when in use, and wherein each first hinge is operatively coupled to a detent for holding the enclosing fixture at selected angles relative to the single support strut.

Further disclosed herein is a plant support device comprising: a single support strut, aligned approximately in a vertical direction when in use; one or more rings, each mounted on the support strut with its own first hinge, wherein each first hinge enables a substantially vertical diametric swing relative to the single support strut when in use, wherein each first hinge is operatively coupled to a detent for holding the ring at selected angles relative to the single support strut, and wherein one or more of the enclosing fixtures comprises a second hinge for opening and closing the enclosing fixture to accommodate a growing plant without damage.

Various refinements and modifications may be applied to the above. For example, in one embodiment, one or more of the enclosing fixtures might include a second hinge for opening and closing the enclosing fixture to accommodate the growing plant without damage, and a locking mechanism for holding the enclosing fixture closed once the plant is accommodated therein. Exemplary locking mechanisms include, without limitation, a magnet that may be mated to a magnetic metal, a pair of magnets, three or more magnets, one or more springs, a latch, a strike plate, a snap fitting, a hook and eye, a sleeve and shaft in combination, a threaded sleeve and shaft in combination, a spring loaded sleeve and shaft in combination, a friction damper on the second hinge, or a spring, operatively coupled to the second hinge to hold the enclosing fixture in a normally closed position. In addition, combinations comprising any of the above may also be useful.

As noted above, the locking mechanism may comprise one or more magnets. Such magnets may comprise commercially available magnets made from ferrous metals, lanthanide metals, actinide metals, alloys, or metal compounds such as metal oxides. Without limitation, suitable magnets may be obtained from National Imports LLC, dba Magcraft, of Vienna, Va.

In addition, the enclosing fixture may also be designed so that it is permanently open; such that the plant can be urged through a suitably sized slot in the enclosing fixture with minimal damage.

The plant support device may further comprise one or more steps that allows the user to apply his or her weight to push the plant support device into the soil. In addition, the step(s) may be configured to stay in an extended position to brace the plant support device and keep it from tipping over under load.

The plant support device may also be configured with a pointed end to aid in pushing it into the ground. In addition, the plant support device may be configured with an auger end, for screwing it into the ground. The auger end may comprise a traditional auger shape a “corkscrew” type auger or an equivalent screw-like structure such as a “corkscrew” like structure.

A detent is a device used to mechanically resist or arrest the rotation of a wheel, axle, or spindle. In the present context, a detent is used to stop rotation of an an enclosing fixture into a fixed position or up and out of the way for storage. Detents may comprise devices of various levels of complexity from a simple metal pin to a machine. In another context, the term may also be used for the method involved. A detent may comprise a tab, interacting with a surface to impede rotation, a gravity or spring-actuated lever paired with a notched wheel, a spring-biased ball bearing coupled to depressions or holes on a surface, a linear spring that snaps a restraint into notches in a surface, or a ratchet, wherein the detent is configured to impede rotation around the first hinge about at least one selected angle. A detent may comprise a separate unit or a portion of the hinge. When the detent comprises a separate unit, it may, nonetheless, reside within the hinge housing.

Hinges may be configured to allow rotation about a given axis. Herein, a first hinge may be used to enable a substantially vertical swing of the enclosing fixture into position, held in place by a detent. A second hinge may be used to open and close the enclosing fixture to enable enclosing a portion of the plant without damage. Hinges may comprise a flap of flexible material such as leather, or may be of a more conventional type, such as, without limitation, a barrel hinge, in which a sectional barrel is secured by a pivot, a pivot hinge, comprising a pivot mounted in openings in a frame, a butt/mortise hinge, comprising at least one inset (mortised) into the mount and enclosing fixture, a continuous hinge that runs the entire length of the mounting object, similar to a barrel hinge, a concealed hinge, comprising a hinge cup and the arm, the other part is the mounting plate, which may be normally closed, and may or may not have a damping mechanism, a butterfly or dovetail hinge, an H hinge, an HL hinge, a counterflap hinge, a flush hinge, a spring hinge, a friction hinge, a security hinge, a lift-off hinge, or a self closing hinge.

Support struts may comprise a unitary structure or may be of collapsible construction, movable between an extended locked position and a retracted locked or unlocked position for convenient storage. A collapsible support strut may be held in place by a variety of locking mechanisms including a set-screw or bolt, a frictional pull-rotation mechanism configured to lock and unlock with a twist, one or more locking dogs, which may comprise springs, bearings or both, a locking groove configured to house the plurality of locking dogs, elastic means, one or more locking collars, pins, rods, cleats, and clamps. In some embodiments, the locking mechanism may be configured to slidably engage with one or more tracks, thereby enabling a user to adjust the support strut by sliding the mechanism along the one or more tracks to a desired position. In other embodiments, instead of being slidably engageable with one or more tracks, the locking mechanism may be configured to be inserted into one or more apertures, holes, ridges, or the like formed into the support strut. For example, in embodiments where the locking mechanism is a pin, the support strut comprises one or more holes along its length, each hole configured to receive the pin or a spring biased ball bearing. The one or more holes may be located between two or more portions of the support strut (i.e., vertical insertion) or along the side (i.e., horizontal insertion), or any combination thereof.

Although the present invention has been shown and described with reference to particular examples, various changes and modifications which are obvious to persons skilled in the art to which the invention pertains are deemed to lie within the spirit, scope and contemplation of the subject matter set forth in the appended claims.

What is claimed is:

1. A plant support device comprising:
a. a single support strut, aligned approximately in a vertical direction when in use;
b. one or more enclosing fixtures, each mounted on the single support strut with its own first hinge, wherein each first hinge enables a substantially vertical swing relative to the support strut when in use, and wherein each first hinge is operatively coupled to a detent for holding the enclosing fixture at selected angles relative to the support strut.

2. The plant support device of claim 1, wherein one or more of the enclosing fixtures comprises a second hinge for opening and closing the enclosing fixture.

3. The plant support device of claim 1, wherein one or more of the enclosing fixtures comprises a second hinge for opening and closing the enclosing fixture; and a locking mechanism for holding the enclosing fixture in a closed position.

4. The plant support device of claim 1, wherein the one or more enclosing fixtures comprise a second hinge for opening and closing each of the one or more enclosing fixtures.

5. The plant support device of claim 4 wherein the one or more enclosing fixtures further comprise a locking mechanism for holding the enclosing fixture in a closed position.

6. The plant support device of claim 5, wherein the locking mechanism comprises one or more magnets, a spring, a latch, a strike-plate, a snap fitting, a hook and eye, a threaded sleeve, a spring-loaded sleeve, a friction damper on the second hinge, or a spring, operatively coupled to the second hinge.

7. The plant support device of claim 1, further comprising at least one step, attached to the single support strut, to aid in pushing the single support strut into the ground.

8. The plant support device of claim 1, further comprising an auger-shaped end, attached to the single support strut, to aid in pushing the single support strut into the ground.

9. The plant support device of claim 1, wherein the detent comprises a tab, interacting with a surface, a gravity or spring-actuated lever paired with a notched wheel, a spring-biased ball bearing coupled to depressions or holes on a surface, a linear spring that snaps a restraint into notches in a surface, or a ratchet, wherein the detent is configured to impede rotation around the first hinge about at least one selected angle.

10. The plant support device of claim 1, wherein the support strut may be extended or collapsed when in use.

11. A plant support device comprising:
a. a single support strut, aligned approximately in a vertical direction when in use;
b. one or more rings, each mounted on the support strut with its own first hinge, wherein each first hinge enables a substantially vertical diametric swing relative to the single support strut when in use, wherein each first hinge is operatively coupled to a detent for holding the ring at selected angles relative to the single support strut, and wherein one or more of the enclosing fixtures comprises a second hinge for opening and closing the ring.

12. The plant support device of claim 11, wherein one or more of the rings comprises a second hinge for opening and closing the ring; and a locking mechanism for holding the ring in a closed position.

13. The plant support device of claim 11, wherein the one or more rings comprise a second hinge for opening and closing each of the one or more rings.

14. The plant support device of claim 13 wherein the one or more rings further comprise a locking mechanism for holding the ring in a closed position.

15. The plant support device of claim 14, wherein the locking mechanism comprises one or more magnets, a spring, a latch, a strike-plate, a snap fitting, a threaded sleeve, a spring-loaded sleeve, a friction damper on the second hinge, or a spring, operatively coupled to the second hinge.

16. The plant support device of claim 11, further comprising at least one step, attached to the single support strut, to aid in pushing the single support strut into the ground.

17. The plant support device of claim 11, further comprising an auger-shaped end, attached to the single support strut, to aid in pushing the single support strut into the ground.

18. The plant support device of claim 11, wherein the detent comprises a tab, interacting with a surface, a gravity or spring-actuated lever paired with a notched wheel, a spring-biased ball bearing coupled to depressions or holes on a surface, a linear spring that snaps a restraint into notches in a surface, or a ratchet, wherein the detent is configured to impede rotation around the first hinge about at least one selected angle.

19. The plant support device of claim 11, wherein the support strut may be extended or collapsed when in use.
